(19) United States
(12) Patent Application Publication
(10) Pub. No.: US 2026/0158794 A1
(43) Pub. Date: Jun. 11, 2026

(54) INK REPLENISHMENT CONTAINER

(71) Applicant: SEIKO EPSON CORPORATION, Tokyo (JP)

(72) Inventors: Yuta KOIKE, Matsumoto-shi (JP); Tadahiro MIZUTANI, Shiojiri-shi (JP); Tadashi WATANABE, Matsumoto-shi (JP); Atsushi KOBAYASHI, Matsumoto-shi (JP); Shun OYA, Kiso-gun (JP)

(73) Assignee: SEIKO EPSON CORPORATION, Tokyo (JP)

(21) Appl. No.: 19/414,662

(22) Filed: Dec. 10, 2025

(30) Foreign Application Priority Data
Dec. 11, 2024 (JP) 2024-216867

(51) Int. Cl. B41J 2/175

(52) U.S. Cl. CPC B41J 2/17523; B41J 2/17553; B41J 2/17596

(57) ABSTRACT

An ink replenishment container includes a container main body portion, an ink outlet forming portion, and a cap. The ink outlet forming portion includes an outlet portion, a protruding portion, a positioning portion, and a male thread portion, the protruding portion has an upper protruding portion, a positioning portion, and a lower protruding portion, the lower protruding portion has a protruding main body portion and a notch portion, and a projection of the cap is spaced from the protruding main body portion at a position facing the notch portion.

The present application is based on, and claims priority from JP Application Serial Number 2024-216867, filed Dec. 11, 2024, the disclosure of which is hereby incorporated by reference herein in its entirety.

### BACKGROUND

### 1. Technical Field

The present disclosure relates to an ink replenishment container.

### 2. Related Art

In the related art, as an example of an ink ejecting apparatus, a printer that can perform printing on a printing medium, such as printing paper, with ink by ejecting ink toward the printing medium from a print head is known. Such a printer includes an ink replenishment-type printer for replenishing ink to an ink tank. JP-A-2019-51723 and JP-A-2023-43905 disclose an ink replenishment container used to replenish ink into an ink replenishment-type ink tank.

In the technique disclosed in JP-A-2019-51723, the ink replenishment container has a slit valve for opening and closing an ink outlet of an ink outlet forming portion. The slit valve is formed of an elastic member such as a silicon film, and is provided with a plurality of slits. When a needle of the printer is inserted into the slit valve, the slit valve is pushed inward and opened. In addition, in a cap mounted state in which the mounting of the cap on the ink outlet forming portion is completed, the slit valve and a protruding portion protruding from a center portion of the cap are separated from each other, and a valve-closed state is maintained.

In the technique disclosed in JP-A-2023-43905, the ink replenishment container has an outlet valve unit in which an ink flow path is formed. The outlet valve unit includes a spring member, a seal portion, and a valve body in order to open and close the ink flow path. The seal portion has a through-hole that forms a portion of the ink flow path. The spring member biases the valve body toward the seal portion, thereby bringing the valve body into contact with the seal portion so as to close the through-hole. As a result, the outlet valve unit is in the valve-closed state.

Here, in order to suppress an increase in the internal pressure of the ink replenishment container due to changes in temperature or air pressure in the cap mounted state, a projection is formed at the center portion of the cap in the technique disclosed in JP-A-2023-43905. The valve body is pushed by the projection in a direction away from the seal portion, thereby maintained the valve-open state.

The cap of the ink replenishment container disclosed in JP-A-2023-43905 is erroneously mounted on the ink outlet forming portion of the ink replenishment container disclosed in JP-A-2019-51723, the projection of the cap pushes and opens the slit valve, and an external force is applied to the slit valve. When the external force from the projection is continuously applied to the slit valve, the slit valve undergoes creep deformation, and the opening and closing function of the valve is deteriorated, so that the ink may leak from the replenishment container main body to the outside. Therefore, there is a demand for a technique capable of preventing a cap having a projection from being erroneously mounted to another type of ink outlet forming portion.

### SUMMARY

According to an aspect of the present disclosure, there is provided an ink replenishment container for replenishing ink to a printer including an ink introduction member having a flow path communicating with an ink tank and extending in a vertical direction, a receiving surface extending in a horizontal direction, a first hole that opens to the receiving surface and in which the ink introduction member is disposed, and a pair of second holes that open to the receiving surface and are disposed with the first hole interposed therebetween. The ink replenishment container includes a container main body portion configured to accommodate the ink, an ink outlet forming portion coupled to the container main body portion, and a cap configured to be attachable to and detachable from the ink outlet forming portion, in which the ink outlet forming portion includes an outlet portion configured to receive the ink introduction member and having a central axis, a protruding portion disposed in a region outside the outlet portion in a direction intersecting the central axis, extending in an axial direction along the central axis, and configured to have a portion of the protruding portion inserted into the second hole, a positioning portion disposed in a region outside the outlet portion in a direction intersecting the central axis of the outlet portion and configured to abut on the receiving surface in a state in which the ink introduction member is inserted into the outlet portion, and a male thread portion disposed below the protruding portion in an upright orientation in which the outlet portion faces upward, the protruding portion includes an upper protruding portion located above the positioning portion and a lower protruding portion located below the positioning portion in the upright orientation, the lower protruding portion includes a protruding main body portion and a notch portion recessed toward the central axis, the cap includes a top wall and a tubular side wall having the central axis, an inner surface of the side wall is provided with a female thread portion configured to be screwed with the male thread portion, and a projection disposed at a position above the female thread portion in a state in which the top wall is positioned on the side wall, and the projection is spaced from the protruding main body portion at a position facing the notch portion.

### BRIEF DESCRIPTION OF THE DRAWINGS

FIG. 1 is a perspective view of a printer according to an embodiment.

FIG. 2 is a perspective view showing a state in which ink is replenished to an ink tank by using an ink replenishment container.

FIG. 3 is a view of an ink accommodating unit with a lid opened, as viewed from a receiving surface side.

FIG. 4 is an exploded perspective view of an ink replenishment container.

FIG. 5 is a first perspective view of a spring valve.

FIG. 6 is a second perspective view of the spring valve.

FIG. 7 is a perspective view of the ink tank.

FIG. 8 is a front view of the ink replenishment container in an upright orientation.

FIG. 9 is a perspective view of the ink replenishment container.

FIG. 10 is a plan view of the ink replenishment container.

FIG. 11 is a first perspective view of a cap.

FIG. 12 is a second perspective view of the cap.

FIG. 13 is a sectional view showing a replenishment state in which ink is replenished.

FIG. 14 is a partial sectional view of the ink replenishment container.

FIG. 15 is a view for explaining an ink replenishment container of a reference example.

FIG. 16 is a view for explaining a detailed structure of a female thread portion of the cap.

FIG. 17 is a view for explaining a detailed configuration of a projection.

FIG. 18 is a first view for explaining the projection.

FIG. 19 is a second view for explaining the projection.

### DESCRIPTION OF EMBODIMENTS

### A. Embodiment

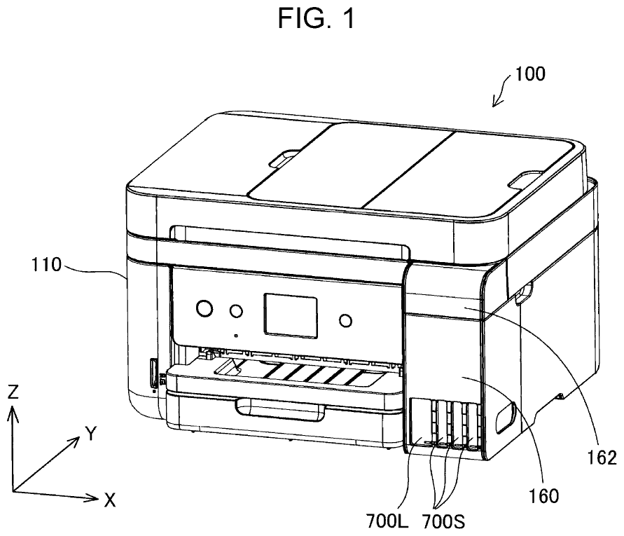

FIG. 1 is a perspective view of a printer 100 according to an embodiment. The printer 100 is an ink jet printer that performs printing by ejecting ink onto a printing medium. In FIG. 1, XYZ axes orthogonal to each other are shown. The X axis corresponds to a width direction of the printer 100, the Y axis corresponds to a front/rear direction of the printer 100, and the Z axis corresponds to a height direction of the printer 100. The printer 100 is installed on a horizontal installation surface defined by an X direction and a Y direction. The “X direction” means a concept in which a +X direction and a −X direction are combined. Similarly, the “Y direction” means a concept in which a +Y direction and a −Y direction are combined, and the “Z direction” is a vertical direction, and means a concept in which a +Z direction, which is a vertical upward direction, and a −Z direction, which is a vertical downward direction, are combined.

The printer 100 includes a housing 110. A carriage (not shown) that is movable in a main scanning direction, which is the X direction, is provided inside the housing 110. A print head that ejects ink onto a printing medium is installed in the carriage. An ink tank accommodating unit 160 that accommodates a plurality of ink tanks 700S and 700L is provided at one end of a front surface of the housing 110. The ink tank accommodating unit 160 has an openable and closable lid 162 on an upper portion thereof. The ink tank 700S is a small-capacity tank, and the ink tank 700L is a large-capacity tank. In the following description, both are simply referred to as an “ink tank 700” without distinction. Each ink tank 700 is coupled to the print head of the carriage by a tube (not shown). That is, the ink tank 700 is a stationary ink tank that is not mounted on the carriage of the printer 100. Further, each ink tank 700 is an ink replenishment-type ink tank to which ink is replenished from the ink replenishment container when the remaining amount of ink is low. Although the ink tank 700 is a stationary ink tank in the present embodiment, the ink tank 700 may be mounted on the carriage of the printer 100.

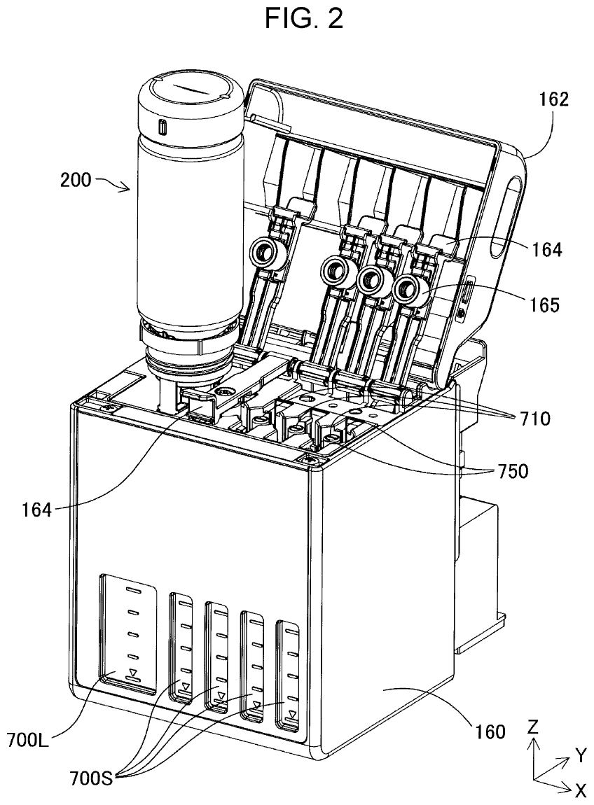

FIG. 2 is a perspective view showing a state in which ink is replenished to the ink tank 700 by using an ink replenishment container 200. A front surface of each ink tank 700 is formed of a transparent member, and the remaining amount of ink in each ink tank 700 can be seen from the outside. When the remaining amount of ink is reduced, as shown in FIG. 2, the ink can be replenished from an ink introduction member 710 having a flow path communicating with the ink tank 700 by opening the lid 162. The ink introduction member 710 is a tubular member extending in the Z direction, which is the vertical direction.

The tubular ink introduction member 710 for replenishing ink to the ink tank 700 is provided on an upper surface of each ink tank 700. The ink tank accommodating unit 160 includes a sealing cap member 164 having a sealing cap 165 for sealing a tip end of the ink introduction member 710. In a state in which ink is not replenished to the ink tank 700, the tip end of the ink introduction member 710 is sealed by the sealing cap 165 of the sealing cap member 164. When the ink is replenished to the ink tank 700, the sealing cap member 164 is removed from the ink introduction member 710, and a tip end portion of the ink replenishment container 200 is inserted into a position of the ink introduction member 710 to replenish the ink. The periphery of the ink introduction member 710 is provided with two inlet forming portions 750 which are fitted to a replenishment-side identification portion, which will be described later, of the ink replenishment container 200. The two inlet forming portions 750 have a shape that is 180-degree rotationally symmetrical about the ink introduction member 710.

In the present specification, the term “ink replenishment” means an operation of supplying ink to the ink tank 700 to increase the remaining amount of ink. Meanwhile, the ink tank 700 does not need to be filled up with the ink through the “ink replenishment”. In addition, the “ink replenishment” also means an operation of filling the empty ink tank 700 with the ink when the printer 100 is used for the first time. As described above, the ink replenishment container 200 replenishes the ink to the ink tank 700 via the ink introduction member 710 having a flow path communicating with the ink tank 700.

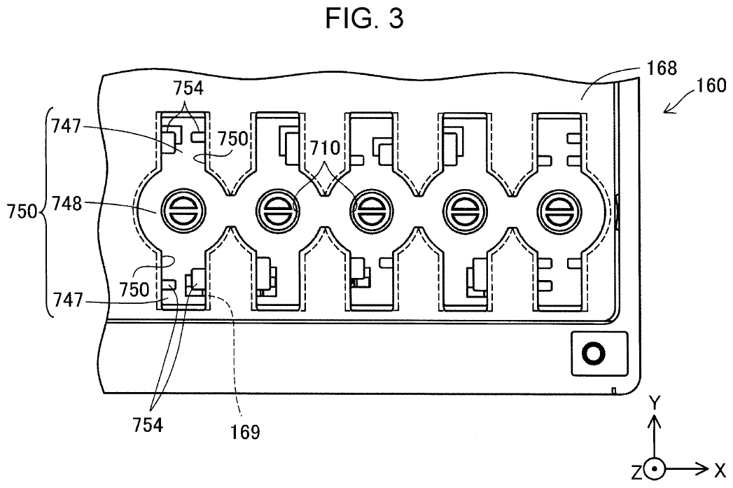

FIG. 3 is a view of the ink tank accommodating unit 160 with the lid 162 opened, as viewed from a receiving surface 168 side. The receiving surface 168 is a horizontal surface and forms an upper surface when the lid 162 of the ink tank accommodating unit 160 is opened. The receiving surface 168 includes inlet forming portions 750 surrounding the periphery of the ink introduction member 710. The inlet forming portion 750 is a recessed portion having a bottom or a through-hole. A region 169 of the receiving surface 168 surrounded by the inlet forming portion 750 and a dotted line is a surface against which a positioning portion, which will be described later, of the ink replenishment container 200 abuts during the ink tank 700 is replenished with ink by the ink replenishment container 200. By the receiving surface 168 abutting the positioning portion of the ink replenishment container 200, a position of the ink replenishment container 200 in the vertical direction with respect to the ink tank 700 at the time of ink replenishment is determined. Here, the inlet forming portion 750 is open to the receiving surface 168.

The inlet forming portion 750 includes a first hole 748 that opens to the receiving surface 168 and a pair of second holes 747. The first hole 748 has a substantially circular outer shape. The first hole 748 accommodates the ink introduction member 710. The pair of second holes 747 are disposed on both sides of the first hole 748 in the Y direction, which is the front/rear direction, with the first hole 748 interposed therebetween. Each of the pair of second holes 747 has a substantially rectangular outer shape.

Each of the pair of second holes 747 has a tank identification member 754 for identifying the ink replenishment container 200 that is capable of being coupled to the corresponding ink introduction member 710. The tank identification member 754 is a recess-and-projection portion having a pattern defined by a plurality of ribs. When an incorrect ink replenishment container 200, such as one having a different ink color, is attempted to be inserted into the ink introduction member 710, the tank identification member 754 collides with a replenishment-side identification member, which will be described later, of the ink replenishment container 200 during the insertion process. This allows the insertion process to be interrupted. On the other hand, when a correct ink replenishment container 200 is attempted to be inserted into the ink introduction member 710, the insertion process can be continued without collision between the tank identification member 754 and the replenishment-side identification member.

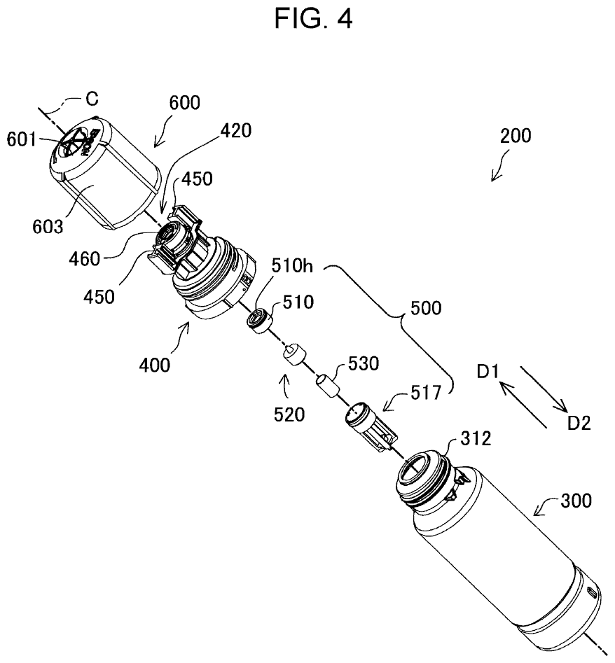

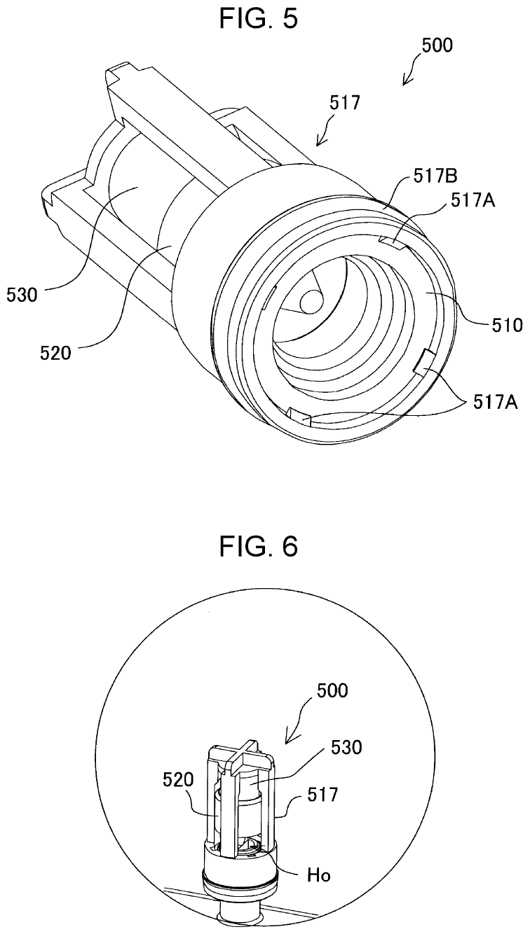

FIG. 4 is an exploded perspective view of the ink replenishment container 200 according to the embodiment. FIG. 5 is a first perspective view of a spring valve 500. FIG. 6 is a second perspective view of the spring valve 500. As shown in FIG. 4, the ink replenishment container 200 includes a container main body portion 300, an ink outlet forming portion 400, the spring valve 500, and a cap 600.

The container main body portion 300 is configured to accommodate the ink. The ink outlet forming portion 400 is coupled to the container main body portion 300. The ink outlet forming portion 400 forms an outlet portion 460 of the ink on a side opposite to the container main body portion 300. The outlet portion 460 is formed in a cylindrical shape so that the ink introduction member 710 is inserted therein. The ink outlet forming portion 400 including the outlet portion 460 has the same central axis C as the ink replenishment container 200.

The spring valve 500 is disposed inside the ink outlet forming portion 400. The spring valve 500 is in a valve-open state when the ink introduction member 710 is inserted from the outlet portion 460, and is in a valve-closed state when the ink introduction member 710 is removed from the outlet portion 460. The cap 600 is configured to be attachable to and detachable from the ink outlet forming portion 400.

An upper end side which is a cap 600 side of the ink replenishment container 200 is referred to as a “front end side”, and a lower end side which is a container main body portion 300 side is referred to as a “rear end side”. The container main body portion 300 is a hollow cylindrical container having an opening at the front end side. An external thread 312 for mounting the ink outlet forming portion 400 is provided in a small-diameter portion at the front end of the container main body portion 300. In the present disclosure, a direction along the central axis C of the ink replenishment container 200, that is, a direction parallel to the central axis C is referred to as an “axial direction”, and a direction orthogonal to the axial direction is referred to as a “radial direction”. A direction from the rear end side of the container main body portion 300 toward the outlet portion 460 located on the front end side in the axial direction is also referred to as a first direction D1. Further, a direction opposite to the first direction D1 is referred to as a second direction D2.

The outlet portion 460 is provided at the tip end of the ink outlet forming portion 400. The ink outlet forming portion 400 is coupled to the container main body portion 300 and includes a tubular portion 420 having the outlet portion 460. The spring valve 500 is mounted in the tubular portion 420. Therefore, the spring valve 500 can also be regarded as a member constituting a portion of the ink outlet forming portion 400. When ink is replenished to the ink tank 700, the ink introduction member 710 shown in FIG. 2 of the ink tank 700 is inserted into the outlet portion 460.

The spring valve 500 includes a valve housing 517, a spring member 530, a valve body 520, and a seal portion 510. The valve housing 517 shown in FIG. 4 allows insertion and removal of the ink introduction member 710. The valve housing 517 extends in the axial direction along the central axis C. The valve housing 517 is mounted in the tubular portion 420 so as to provide a gap in the radial direction between the valve housing 517 and the tubular portion 420. The valve housing 517 accommodates the spring member 530, the valve body 520, and the seal portion 510 inside. As shown in FIG. 5, the valve housing 517 has a retaining portion 517A for preventing the seal portion 510 from coming off from the valve housing 517 at the tip end side and an engaging portion 517B for engaging with the tubular portion 420. For this reason, since the spring valve 500 alone can be attached and detached as an element of the ink replenishment container 200, the manufacturing is easy.

The spring member 530 shown in FIG. 4 is supported in the valve housing 517 by the valve housing 517. The spring member 530 is accommodated on the rear end side which is the second direction D2 ide in the axial direction in the valve housing 517. The spring member 530 can be formed of, for example, metal. In the present embodiment, the spring member 530 is a coil spring. The spring member 530 biases the valve body 520 in the first direction D1 toward the outlet portion 460 in the axial direction. That is, the spring member 530 biases the valve body 520 toward the seal portion 510.

The valve body 520 is disposed to be movable in the axial direction in the valve housing 517. The valve body 520 opens and closes a flow path for communicating the container main body portion 300 with a through-hole 510h of the seal portion 510. The valve body 520 is located closer to the outlet portion 460 than the spring member 530 in the axial direction. The valve body 520 is biased by the spring member 530 in the first direction D1. The valve body 520 faces the seal portion 510 in the axial direction.

The seal portion 510 shown in FIG. 4 is supported by the valve housing 517 inside the valve housing 517. That is, the seal portion 510 is mounted in the valve housing 517. The seal portion 510 is formed of an elastic member. The seal portion 510 is formed of, for example, a rubber member such as an elastomer having rubber elasticity. The elements of the ink replenishment container 200 other than the spring member 530 and the seal portion 510 may be formed of a synthetic resin such as polyethylene or polypropylene. The seal portion 510 is located closer to the outlet portion 460 than the valve body 520 in the axial direction. The seal portion 510 has an annular shape. The through-hole 510h penetrating in the axial direction is formed in the seal portion 510. The ink introduction member 710 is inserted into and removed from the through-hole 510h in the axial direction.

In the spring valve 500, the spring member 530 biases the valve body 520 toward the seal portion 510. That is, the spring member 530 holds a state of the spring valve 500 in a valve-closed state in which the valve body 520 is in contact with the seal portion 510 so as to close the through-hole 510h of the seal portion 510.

As shown in FIG. 6, the valve housing 517 has a total of four through-holes Ho penetrating in the radial direction. The through-hole Ho communicates with a radial gap between the valve housing 517 and the valve body 520. The through-holes Ho are formed to extend in the axial direction. In the valve-open state, a flow path, which will be described later, formed inside the ink introduction member 710 and the through-hole Ho communicate with each other, whereby gas-liquid exchange is performed between the ink introduction member 710 and the ink replenishment container 200. As a result, ink is replenished from the ink replenishment container 200 to the ink tank 700.

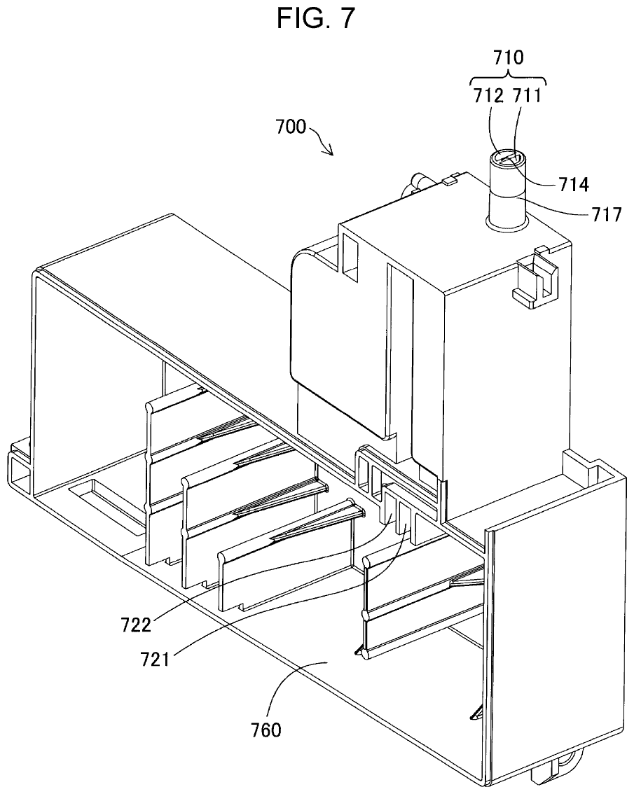

A configuration of the ink tank 700 before further detailed description of the ink replenishment container 200 will be described. FIG. 7 is a perspective view of the ink tank 700 of the embodiment. The ink introduction member 710 of the ink tank 700 protrudes upward from the ink tank 700. The ink introduction member 710 has a side surface 717 and a tip end 715.

The ink introduction member 710 has two flow paths 711 and 712. The two flow paths 711 and 712 are partitioned by a partition wall 714. When ink is replenished, one of the flow paths 711 and 712 forms a flow path of ink from the ink replenishment container 200, and the other thereof forms a flow path of air from the ink tank 700 to the ink replenishment container 200. The number of the flow paths 711 and 712 included in the ink introduction member 710 is not limited to two, and may be three or more as long as there are a plurality of flow paths.

The tip end 715 of the ink introduction member 710 is flat, and the two flow paths 711 and 712 open at the tip end 715 of the ink introduction member 710. A portion of the tip end 715 of the ink introduction member 710 corresponds to an end portion of the partition wall 714. The two flow paths 711 and 712 respectively communicate with two in-tank flow paths 721 and 722 protruding into an ink accommodating chamber 760 below. The lower ends of the in-tank flow paths 721 and 722 extend to a position below a ceiling wall of the ink accommodating chamber 760. This is because, when ink is replenished from the ink replenishment container 200 to the ink tank 700, gas-liquid exchange stops when the liquid level in the ink accommodating chamber 760 reaches the lower ends of the in-tank flow paths 721 and 722, and accordingly ink replenishment also stops, thereby facilitating the ink replenishment operation.

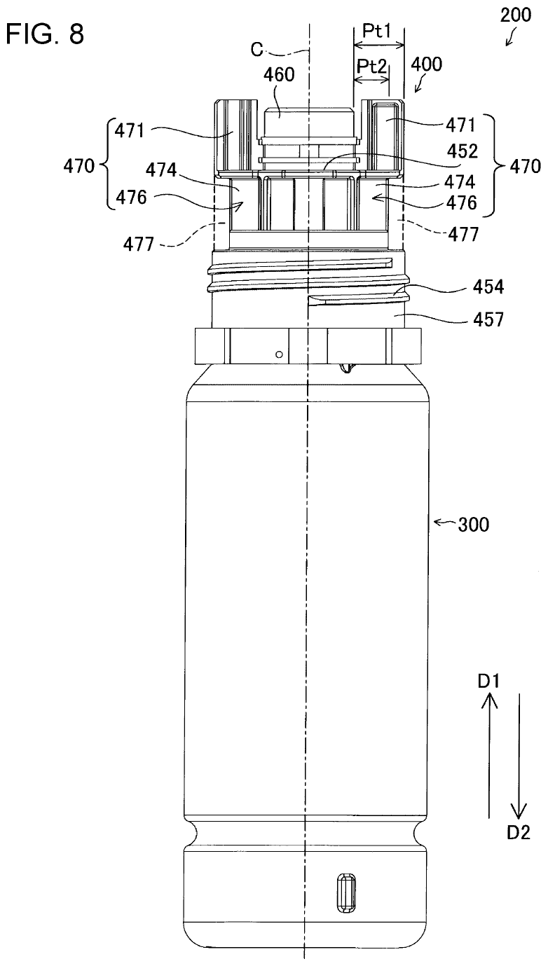

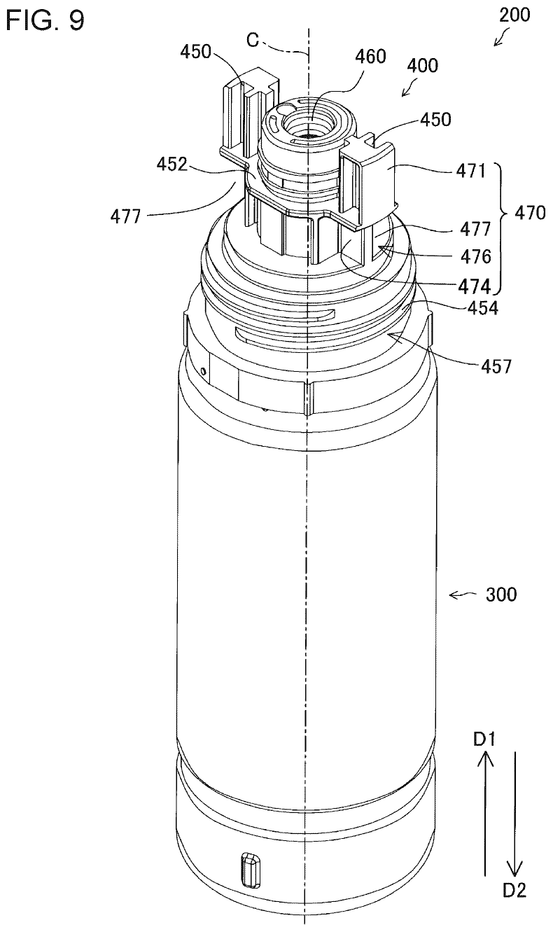

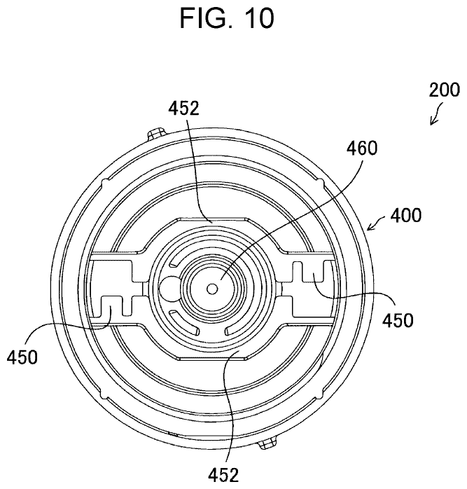

The detailed structure of the ink replenishment container 200 will be described with reference to FIG. 8 and the subsequent drawings. FIG. 8 is a front view of the ink replenishment container 200 in an upright orientation. FIG. 9 is a perspective view of the ink replenishment container 200. FIG. 10 is a plan view of the ink replenishment container 200. The ink replenishment container 200 shown in FIGS. 8 to 10 is in a state in which the cap 600 is removed. The “upright orientation of the ink replenishment container 200” is a state in which the outlet portion 460 faces upward and in which the ink replenishment container 200 is placed on a horizontal surface such as a desk with the bottom portion of the container main body portion 300 facing downward. The state in which the outlet portion 460 faces upward is a state in which a direction in which the outlet portion 460 opens is the vertically upward direction. As shown in FIG. 2 described above, replenishment of ink into the ink tank 700 is performed in an inverted state in which the front end side of the ink replenishment container 200 faces downward.

As shown in FIGS. 8 and 9, the ink outlet forming portion 400 of the ink replenishment container 200 includes a protruding portion 470, a positioning portion 452, and a base end portion 457 in which a male thread portion 454 is formed, in addition to the outlet portion 460.

The protruding portion 470 is disposed in a region outside the outlet portion 460 in a direction intersecting the central axis C. In detail, the protruding portion 470 protrudes radially outward from a side wall of the outlet portion 460. Two protruding portions 470 are provided at opposite positions with the outlet portion 460 interposed between them. The protruding portion 470 extends to have a constant dimension in the axial direction. The protruding portion 470 is configured to be partially inserted into the second hole 747 shown in FIG. 3. The portion inserted into the second hole 747 is an upper protruding portion 471, which will be described later, of the protruding portion 470, which is located on the first direction D1 side.

Each of the two protruding portions 470 includes the upper protruding portion 471 and a lower protruding portion 476. The upper protruding portion 471 is located above the positioning portion 452 in the upright orientation in which the outlet portion 460 faces upward. The upper protruding portion 471 has a substantially rectangular parallelepiped shape. In the axial direction, an end portion of the upper protruding portion 471 on the first direction D1 side is located slightly closer to the first direction D1 than the outlet portion 460. As shown in FIGS. 9 and 10, the upper protruding portion 471 is provided with a replenishment-side identification portion 450 corresponding to the tank identification member 754 shown in FIG. 3. The replenishment-side identification portion 450 is formed as a groove portion for receiving the tank identification member 754 formed by a rib. The shape of the replenishment-side identification portion 450 varies depending on the type of ink accommodated in the ink replenishment container 200. That is, the replenishment-side identification portion 450 has an identification shape for identifying the type of ink accommodated in the container main body portion 300.

At the time of ink replenishment, the replenishment-side identification portion 450 is inserted or fitted into the tank identification member 754 shown in FIG. 3, which is provided around the ink introduction member 710 of the ink tank 700, whereby the ink replenishment container 200 is positioned in a direction orthogonal to the central axis C. The positioning is, for example, at least one of a function of preventing erroneous ink injection by fitting the ink replenishment container 200 for replenishing yellow ink to the inlet forming portion 750 corresponding to the ink tank 700 accommodating yellow ink and preventing the ink replenishment container 200 for replenishing other color inks such as magenta ink and cyan ink from being fitted, and a function of stabilizing the ink injection orientation of the ink replenishment container 200. The function of preventing erroneous ink injection is to prevent not only erroneous injection of a different color ink but also, for example, in the case of black ink, erroneous injection between dye-based black ink and pigment-based black ink. In the present embodiment, the two replenishment-side identification portions 450 have a shape of 180-degree rotational symmetry about the central axis C of the ink replenishment container 200. Similarly, the tank identification member 754 provided on the ink introduction member 710 of the ink tank 700 also has a shape of 180-degree rotational symmetry about the ink introduction member 710. When ink is replenished, by fitting the replenishment-side identification portion 450 of the ink replenishment container 200 to the tank identification member 754, the orientation of the ink replenishment container 200 is limited to two orientations that are rotationally symmetric by 180 degrees. Thus, the ink replenishment container 200 can remain in a stable orientation during ink replenishment. However, the replenishment-side identification portion 450 may be omitted. The term “fit” includes a loose fit with some clearance.

As shown in FIGS. 8 and 9, in the upright orientation, the lower protruding portion 476 is located below the positioning portion 452 and the upper protruding portion 471. The lower protruding portion 476 has a protruding main body portion 474 and a notch portion 477. The protruding main body portion 474 is a plate-like member having a thickness smaller than that of the upper protruding portion 471. As shown in FIG. 8, a protruding length Pt2 of the protruding main body portion 474 protruding radially outward from the side surface of the outlet portion 460 is smaller than a protruding length Pt1 of the upper protruding portion 471 protruding radially outward from the side surface of the outlet portion 460. That is, the lower protruding portion 476 forms a space region partitioned by the dotted line by a difference between the protruding length Pt1 and the protruding length Pt2. This space region can also be regarded as the notch portion 477 recessed toward the central axis C. The notch portion 477 is a region recessed toward the central axis C, in the radial direction, relative to the upper protruding portion 471.

As shown in FIGS. 9 and 10, the positioning portion 452 is disposed in a region outside the outlet portion 460 in the radial direction intersecting the central axis C of the outlet portion 460. The positioning portion 452 is disposed at a boundary portion between the upper protruding portion 471 and the lower protruding portion 476 in the axial direction. The positioning portion 452 is configured to abut on the receiving surface 168 shown in FIG. 3 in a state in which the ink introduction member 710 is inserted into the outlet portion 460. The positioning portion 452 is a flat surface having an outer shape larger than the outer shape of the inlet forming portion 750 shown in FIG. 3. The positioning portion 452 is a surface facing the first direction D1 side. As shown in FIG. 10, the positioning portions 452 are disposed on both sides of the outlet portion 460 in the radial direction. When the positioning portion 452 abuts against the receiving surface 168, the position of the ink replenishment container 200 with respect to the ink tank 700 in the vertical direction at the time of ink replenishment is determined.

As shown in FIG. 9, the base end portion 457 having the male thread portion 454 is a tubular member. The base end portion 457 has a larger outer diameter than the outlet portion 460. The base end portion 457 having the male thread portion 454 is disposed below the protruding portion 470 in the upright orientation. The male thread portion 454 to be screwed with the cap 600 is formed on an outer peripheral surface of the base end portion 457. The male thread portion 454 is constituted by a plurality of stages of male threads. On the inner peripheral surface of the base end portion 457, a thread to be screwed with the external thread 312 of the container main body portion 300 shown in FIG. 4 is formed.

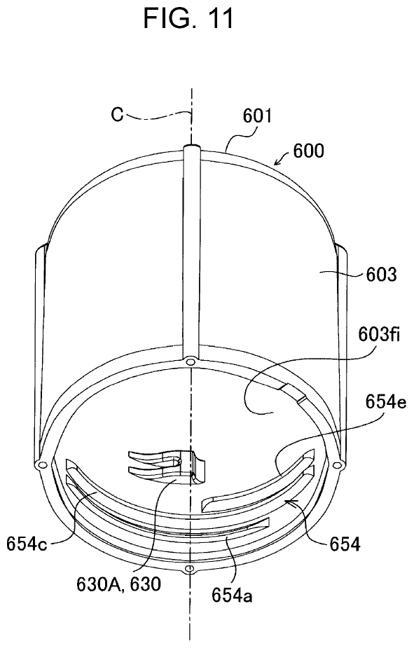

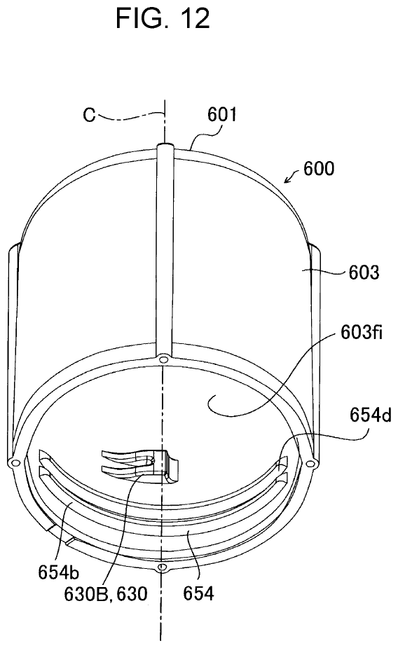

FIG. 11 is a first perspective view of the cap 600. FIG. 12 is a second perspective view of the cap 600. A detailed configuration of the cap 600 will be described mainly with reference to FIGS. 4, 11, and 12. As shown in FIG. 4, the cap 600 has a top wall 601 axially opposed to the outlet portion 460, and a tubular side wall 603 having the central axis C. The top wall 601 is located at the uppermost position in the upright orientation of the ink replenishment container 200.

As shown in FIGS. 11 and 12, the female thread portion 654 and two projections 630 are provided on an inner surface 603fi of the side wall 603. The female thread portion 654 is configured to be screwed with the male thread portion 454 of the ink outlet forming portion 400 shown in FIG. 9. The female thread portion 654 is constituted by a plurality of stages of female threads 654a, 654b, 654c, 654d, and 654e. Each of the stages of female threads 654a, 654b, 654c, 654d, and 654e has a length of about a half circumference or less than a half circumference, without extending over the entire circumferential direction on the inner surface 603fi of the side wall 603.

Two projections 630 are located above the female thread portion 654 in a state in which the top wall 601 is located on the side wall 603, that is, in the upright orientation. When the two projections 630 are distinguished from each other, reference numerals 630A and 630B are used. The two projections 630A and 630B have the same shape. The two projections 630A and 630B protrude radially inward from the inner surface 603fi of the side wall 603. The two projections 630A and 630B are provided at positions opposed to each other in the radial direction. The two projections 630A and 630B are elements for preventing the cap 600 from being erroneously mounted on an ink replenishment container of a type in which an ink flow path is opened and closed by a slit valve having a slit formed therein that is different from the spring valve 500 shown in FIG. 4. This will be described in detail later.

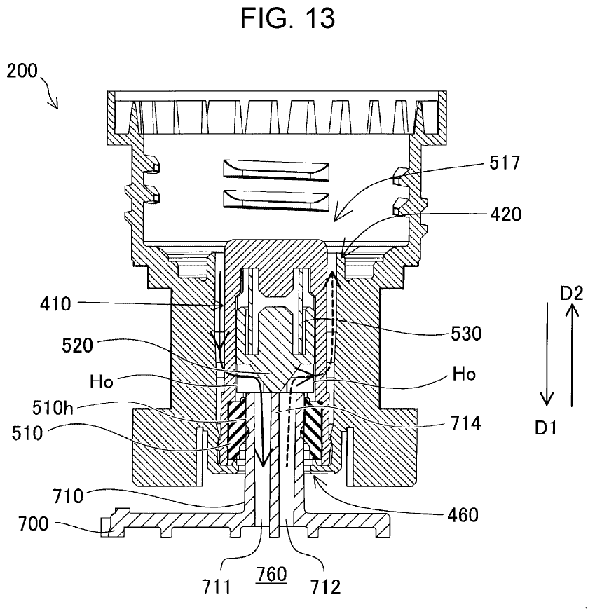

FIG. 13 is a sectional view showing a replenishment state in which ink is replenished from the ink replenishment container 200 to the ink tank 700. In this replenishment state, the ink replenishment container 200 is in an inverted state. The ink introduction member 710 of the ink tank 700 is inserted into a tubular flow path portion 410 which is a flow path of the fluid in the ink outlet forming portion 400 via the through-hole 510h of the seal portion 510. Thus, the valve body 520 is displaced by the ink introduction member 710 in the second direction D2, which is a direction away from the seal portion 510, so that the valve body 520 is spaced from the seal portion 510. As a result, the spring valve 500 is in a valve-open state. The ink in the container main body portion 300 is supplied to the ink introduction member 710 via the tubular flow path portion 410 formed by a gap between the inner peripheral surface of the tubular portion 420 and the valve housing 517, and air flows into the container main body portion 300 from the ink accommodating chamber 760. As a result, the gas-liquid exchange is performed, and the ink is replenished to the ink tank 700. In FIG. 13, the arrow indicated by the solid line schematically indicates the flow of ink, and the arrow indicated by the dashed line schematically indicates the flow of air.

When the replenishment of ink to the ink tank 700 is completed and the ink replenishment container 200 is removed from the ink introduction member 710, the valve body 520 is brought into contact with the seal portion 510 by the biasing force of the spring member 530. As a result, the through-hole 510h of the seal portion 510 is blocked by the valve body 520, so that the spring valve 500 is brought into a valve-closed state. When the spring valve 500 is in the valve-closed state, the ink in the ink replenishment container 200 can be prevented from leaking to the outside. When the ink is replenished from the ink replenishment container 200 to the ink tank 700, it is not necessary to squeeze the container main body portion 300. As described above, a type of ink replenishment container capable of replenishing the ink without squeezing the container main body portion 300 is also referred to as a “non-squeeze type”.

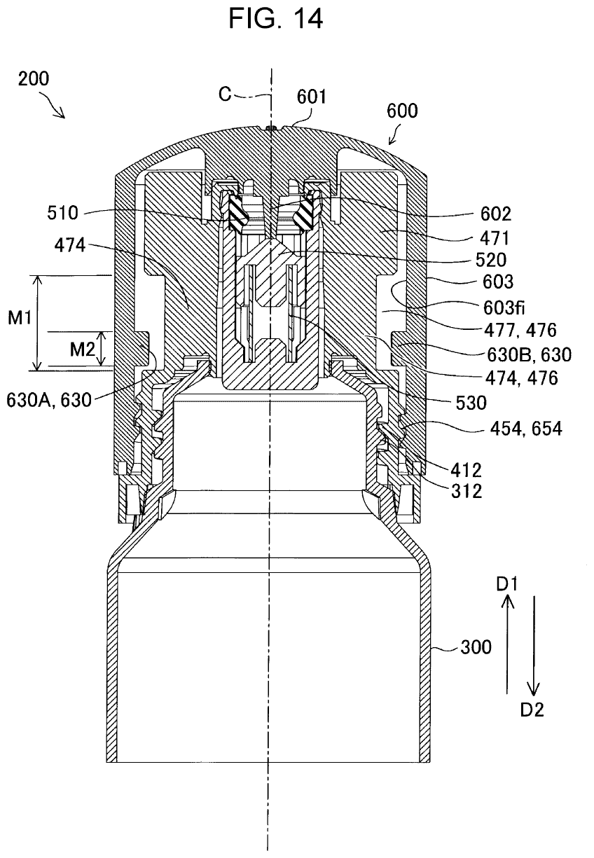

FIG. 14 is a partial sectional view of the ink replenishment container 200. FIG. 14 shows a state in which the cap 600 is mounted on the ink outlet forming portion 400 and the cap 600 is closed. The cap 600 includes a center projection 602 that protrudes from a center portion of the top wall 601 toward the valve body 520. In a state in which the cap 600 is mounted on the ink outlet forming portion 400, that is, in a state in which the cap 600 is closed, the center projection 602 presses the valve body 520 in the second direction D2 which is a direction away from the seal portion 510. That is, in a state in which the cap 600 is closed, the valve body 520 is pressed by the center projection 602 in the second direction D2 which is a direction opposite to the biasing direction of the spring member 530. As a result, the valve body 520 is spaced from the seal portion 510, and the spring valve 500 is brought into a valve-open state. This valve-open state is maintained from the state in which the cap 600 is closed to a predetermined point of time in the opening process of the cap 600. In detail, the valve-open state using the center projection 602 is maintained until a predetermined point of time at which the cap 600 is rotated about the central axis C and a gap is formed between the cap 600 and the ink outlet forming portion 400. Thus, when the internal pressure of the container main body portion 300 increases due to changes in air pressure or temperature, the inside of the container main body portion 300 can be released to the atmosphere in the opening process of the cap 600, thereby reducing the internal pressure. That is, by providing the cap 600 having the projection 630, when the internal pressure of the ink replenishment container 200 increases due to the changes in atmospheric pressure or temperature, a region where the internal pressure increases can be released to the atmosphere when the cap 600 is opened from the closed state, and therefore, the ejection of the ink can be prevented.

In addition, the projection 630 formed on the inner surface 603fi of the side wall 603 of the cap 600 is spaced from the protruding main body portion 474 without interference at a position facing the notch portion 477. In the cap mounted state shown in FIG. 14, a portion of the projection 630 is located in the notch portion 477, and the projection 630 is spaced from the protruding main body portion 474. In addition, in the process of mounting the cap 600 to the ink outlet forming portion 400 or in the opening process, the projection 630 passes through the notch portion 477, which is a space region, without interfering with the protruding main body portion 474. Thus, the cap 600 having the projection 630 can be attached to and detached from the ink outlet forming portion 400.

In addition, in the axial direction, a notch dimension M1 which is a dimension of the notch portion 477 and a projection dimension M2 of the projection 630 have a relationship represented by the following Expression (1).

$$M 1 > P \times N + M 2 \qquad Expression ( 1 )$$

Here, “P” is a pitch of the male thread portion 454, and “N” is the number of engaged thread turns between the male thread portion 454 and the female thread portion 654. That is, the “P×N” represents an engagement length between the male thread portion 454 and the female thread portion 654.

Further, the “P×N” in the above-described Expression (1) indicates a distance by which the projection 630 moves in the axial direction from an initial mounting time point at which the male thread portion 454 and the female thread portion 654 start to engage with each other to a mounting completion time point at which the mounting of the cap 600 to the ink outlet forming portion 400 is completed when the cap 600 is being closed. That is, having the relationship of the above-described Expression (1) means that the projection 630 can pass through the notch portion 477 or the projection 630 can be located in the notch portion 477 without the projection 630 interfering with the upper protruding portion 471 or the protruding main body portion 474 during a mounting operation period of the cap 600 and a removal operation period of the cap 600. The mounting operation period is a period from the initial mounting time point to the mounting completion time point. The removal operation period is a period from the mounting completion time point of the cap 600 to a time point at which engagement between the male thread portion 454 and the female thread portion 654 is released. As described above, since the ink replenishment container 200 has the relationship of the above-described Expression (1), when the male thread portion 454 and the female thread portion 654 are screwed to each other or when the screwing between the male thread portion 454 and the female thread portion 654 is released, the projection 630 can pass through the notch portion 477 or the projection 630 can be located in the notch portion 477. Therefore, it is possible to suppress hindrance of the attachment/detachment operation of the cap 600 with respect to the ink outlet forming portion 400.

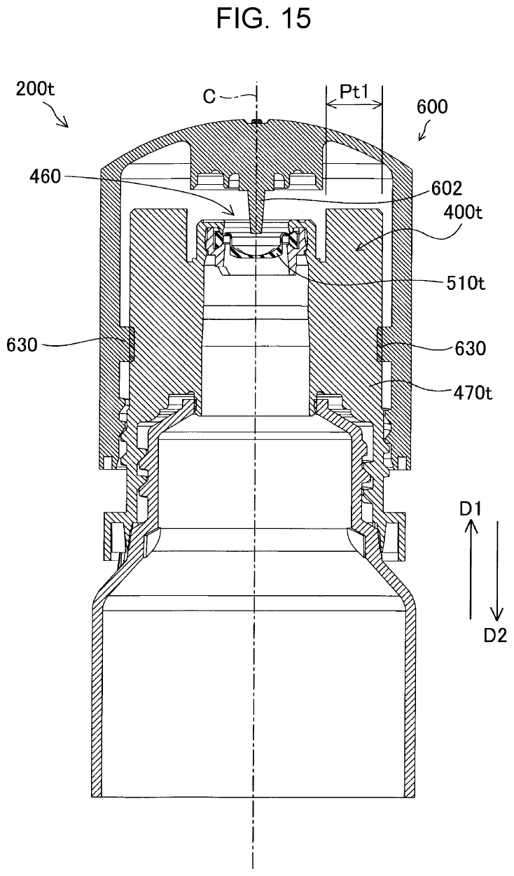

FIG. 15 is a view for explaining an ink replenishment container 200t of a reference example. The ink replenishment container 200t is different from the ink replenishment container 200 in the shape of a protruding portion 470t of an ink outlet forming portion 400t and in that the ink replenishment container 200t has a slit valve 510t instead of the spring valve 500. Accordingly, since the other configurations are of similar configuration, the same reference numerals are given to components similar to those of the ink replenishment container 200, and description thereof will be omitted as appropriate.

In FIG. 15, a case where the cap 600 for the ink outlet forming portion 400 is erroneously mounted on the ink outlet forming portion 400t will be described. The slit valve 510t is a disc-shaped valve, and is formed of a rubber member having rubber elasticity such as elastomer. A plurality of slits are formed in the slit valve 510t. Each slit extends in the radial direction from the center of the slit valve. The slit valve 510t is normally in a valve-closed state. On the other hand, when the ink introduction member 710 is inserted into the ink outlet forming portion 400t from the outlet portion 460, the slit valve 510t is pushed by the ink introduction member 710 to be opened. The slit valve 510t also opens when the internal pressure of the container main body portion 300 increases to a level equal to or higher than a certain level due to changes in temperature or pressure.

In the protruding portion 470t of the ink outlet forming portion 400t, elements corresponding to the upper protruding portion 471 shown in FIG. 14 are located up to a portion corresponding to the lower protruding portion 476. That is, the protruding portion 470t does not have the notch portion 477, and has a certain protruding length Pt1 from the side surface of the outlet portion 460. The protruding length Pt1 of the protruding portion 470t is, for example, the same as the protruding length Pt1 of the upper protruding portion 471 shown in FIG. 8.

When the cap 600 for the ink outlet forming portion 400 is erroneously mounted on the ink outlet forming portion 400t, the center projection 602 pushes and opens the slit valve 510t, and the external force from the center projection 602 is continuously applied to the slit valve 510t in the cap mounted state. As a result, the slit valve 510t may undergo creep deformation, the opening and closing function of the valve may deteriorate, and ink may leak from the container main body portion 300 to the outside. On the other hand, when the cap 600 is erroneously mounted on the ink outlet forming portion 400t, the mounting operation can be hindered as follows. That is, when the user rotates the cap 600 around the central axis C with respect to the ink outlet forming portion 400t in order to close the cap 600, the projection 630 collides with the protruding portion 470t, thereby hindering the mounting operation of rotating the cap 600. As a result, it is possible to reduce the possibility that the cap 600 is erroneously mounted on the ink replenishment container 200t having the ink outlet forming portion 400t. A correct cap to be mounted on the ink outlet forming portion 400t does not have the projection 630. The correct cap is a cap having no center projection 602, or a cap having a center projection 602 with a length that does not open the slit valve 501t when the cap 600 is mounted.

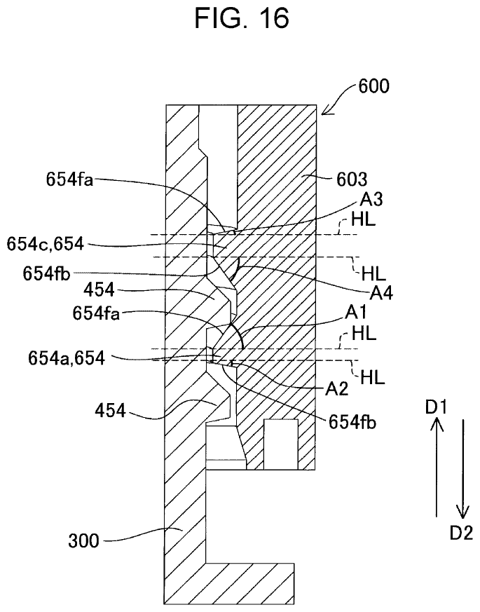

FIG. 16 is a view for explaining a detailed structure of the female thread portion 654 of the cap 600. As shown in FIGS. 11 and 12, the female thread portion 654 has a plurality of female threads 654a, 654b, 654c, 654d, and 654e disposed at different positions in the axial direction. Among the plurality of female threads 654a, 654b, 654c, 654d, and 654e, the female thread 654a located farthest from the top wall 601 in the axial direction is referred to as a first female thread 654a. In the thread of the female thread 654, a surface on the top wall 601 side is referred to as a thread upper surface 654fa, and a surface opposite to the thread upper surface 654fa is referred to as a thread lower surface 654fb. In the above case, in the first female thread 654a, an angle A1 formed between a plane HL orthogonal to the central axis C and the thread upper surface 654fa is larger than an angle A2 formed between the plane HL and the thread lower surface 654fb. That is, in the first female thread 654a, the degree of inclination of the thread upper surface 654fa is gentler than the degree of inclination of the thread lower surface 654fb. For example, the angle A1 is 50 degrees or more, preferably 60 degrees or more, and more preferably about 70 degrees.

Here, when the user attempts to mount the cap 600 to the ink outlet forming portion 400 in an orientation different from the correct orientation, for example, in an inclined orientation, in the mounting operation process of the cap 600, there may be a case where the engagement between the first female thread 654a of the female thread portion 654 and the male thread portion 454 is not correctly performed. In this case, a so-called deadlock state in which the rotation operation for the attachment/detachment operation of the cap 600 is restricted occurs, and the attachment/detachment operation of the cap 600 may not be performed. In this case, since the angle A1 formed between the plane HL and the thread upper surface 654fa is larger than the angle A2 formed between the plane HL and the thread lower surface 654fb in the first female thread 654a, when the cap 600 is pulled up in the first direction D1 away from the ink outlet forming portion 400, the engagement between the thread upper surface 654fa of the first female thread 654a and the male thread portion 454 can be released. Therefore, the cap 600 in the deadlock state can be removed from the ink outlet forming portion 400.

In the present embodiment, the second to fifth female threads 654b to 654e have the same shape, and the shape is different from that of the first female thread 654a. In the second to fifth female threads 654b to 654e, an angle A3 between the thread upper surface 654fa and the plane HL is smaller than an angle A4 between the thread lower surface 654fb and the plane HL.

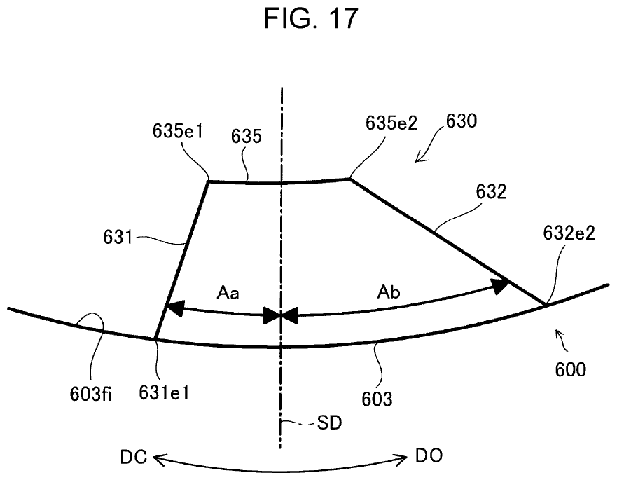

FIG. 17 is a view for explaining a detailed configuration of the projection 630. FIG. 17 is a schematic view of the cap 600 as viewed in the axial direction. For example, FIG. 17 is a view of the cap 600 as viewed from the second direction D2 side in the direction along the axial direction, that is, from an opening side facing the top wall 601 of the cap 600.

The projection 630 has an asymmetric shape as viewed in the axial direction. The projection 630 has a top surface portion 635 located on the radially inner side, a first projection surface 631, and a second projection surface 632. The top surface portion 635 is a portion farthest from the inner surface 603fi of the side wall 603, and is a top portion of the projection 630. The first projection surface 631 is a surface extending from one end portion 635e1 of the top surface portion 635 to the inner surface 603fi. That is, when the cap 600 is viewed in the axial direction, the first projection surface 631 has the end portion 635e1 and an end portion 631e1 coupled to the inner surface 603fi. The first projection surface 631 is located on the side where the cap 600 is rotated in a closing direction DC. The second projection surface 632 is a surface extending from the other end portion 635e2 of the top surface portion 635 to the inner surface 603fi. That is, when the cap 600 is viewed in the axial direction, the second projection surface 632 has the end portion 635e2 and an end portion 632e2 coupled to the inner surface 603fi. The second projection surface 632 is located on the side where the cap 600 is rotated in an opening direction D0. Each of the first projection surface 631 and the second projection surface 632 may be a flat surface, a curved surface, a combination of a plurality of flat surfaces, a combination of a plurality of curved surfaces, or a combination of a flat surface and a curved surface.

When the cap 600 is viewed in the axial direction, an inclination angle of the second projection surface 632 is gentler than an inclination angle of the first projection surface 631. That is, when the cap 600 is viewed in the axial direction, an angle Aa formed between a reference direction SD perpendicular to the top surface portion 635 and the first projection surface 631 is smaller than an angle Ab formed between the reference direction SD and the second projection surface 632. The top surface portion 635 may be a flat surface or a curved surface. When the top surface portion 635 is a curved surface, a direction orthogonal to a virtual plane coupling the end portion 635e1 and the end portion 635e2 is the reference direction SD. The angle Aa is, for example, 30 degrees or less. The angle Aa may be an angle smaller than zero. That is, the first projection surface 631 may extend from the end portion 635e1 to the inner surface 603fi toward the dotted line indicating the reference direction SD depicted in FIG. 17. The angle Ab is, for example, in a range of 30 degrees or more and 80 degrees or less.

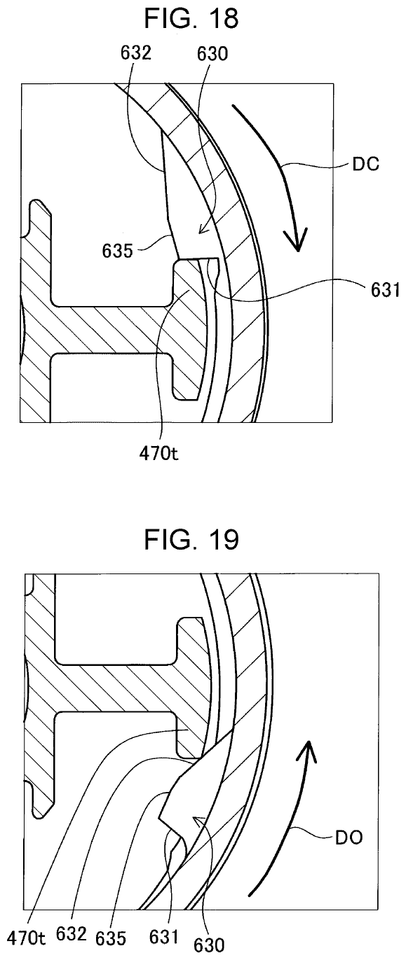

FIG. 18 is a first view for explaining the projection 630. FIG. 19 is a second view for explaining the projection 630. FIGS. 18 and 19 schematically show a case where the cap 600 is erroneously attached to or detached from the ink outlet forming portion 400t shown in FIG. 15.

When the user attempts to mount the cap 600 to the ink outlet forming portion 400t having the protruding portion 470t, the cap 600 is rotated in the closing direction DC. In this case, as shown in FIG. 18, the interference between the first projection surface 631 having a steep inclination angle and the protruding portion 470t increases, and it is possible to restrict the cap 600 from being rotated in the closing direction DC by the projection 630 riding over the protruding portion 470t. This makes it easy to notice that the cap 600 is about to be erroneously mounted to another type of incompatible ink outlet forming portion 400t.

On the other hand, the second projection surface 632 having a large angle Ab formed with the reference direction SD and a gentle inclination angle is likely to ride over the protruding portion 470t. Therefore, even when the first projection surface 631 rides over the protruding portion 470t, as shown in FIG. 19, the user rotates the cap 600 in the opening direction D0, and thus the second projection surface 632 can easily ride over the protruding portion 470t. As a result, the cap 600 can be removed from the incompatible ink outlet forming portion 400t.

According to the above-described embodiment, when the cap 600 is attempted to be mounted to the ink outlet forming portion 400t having no notch portion 477 and provided with the protruding portion 470t, the projection 630 interferes with the protruding portion 470t. Therefore, the user can easily notice that the cap 600 is erroneously being attempted to be mounted to the ink replenishment container 200t having another type of incompatible ink outlet forming portion 400t. Accordingly, the possibility that the cap 600 is erroneously mounted to another type of ink outlet forming portion 400t is reduced. In addition, since the possibility that the cap 600 is erroneously mounted to another type of ink outlet forming portion 400t is reduced, it is possible to suppress deterioration of the function of another type of ink outlet forming portion 400t due to the cap 600. For example, it is possible to suppress damage or deformation of the protruding portion 470t which does not have the notch portion 477 due to the cap 600 being forcibly mounted on another type of ink outlet forming portion 400t. In addition, when the user attempts to mount the cap 600 to the suitable ink outlet forming portion 400, the projection 630 of the cap 600 is spaced from the protruding main body portion 474 without interfering with the protruding main body portion 474, and thus it is possible to easily mount the cap 600 to the suitable ink outlet forming portion 400. Therefore, since the cap 600 can be easily mounted to the suitable ink outlet forming portion 400, it is possible to suppress the ink from leaking to the outside of the ink replenishment container 200 due to incomplete mounting of the cap 600. In addition, since the upper protruding portion 471 is longer than the lower protruding portion 476 in the direction intersecting the central axis C, that is in a radial direction around the central axis C, it is possible to stabilize the upside-down posture of the ink replenishment container 200 when the ink replenishment container 200 is mounted on the printer 100 for ink replenishment. In addition, since the upper protruding portion 471 is inserted into the rectangular second hole 747 shown in FIG. 3 and the ink replenishment orientation is established, it is possible to maintain the stable ink replenishment orientation as shown in FIG. 2.

According to the above-described embodiment, as shown in FIG. 9, the upper protruding portion 471 is provided with the replenishment-side identification portion 450, which is an identification shape. Thus, the upper protruding portion 471 can be used for identification to identify the type of ink accommodated in the container main body portion 300.

### B. Other Embodiments

### B-1. Another Embodiment 1

According to the above-described embodiment, as shown in FIGS. 11, 12, and 14, the number and the positions of the projections 640 are two at positions facing each other in the radial direction, but the present disclosure is not limited thereto. The number of projections 640 may be one, or may be three or more at equal intervals in the circumferential direction. However, it is preferable that two projections 630 are provided at positions facing each other in the radial direction as in the above-described embodiment. When one projection 630 is provided, even when the cap 600 is erroneously mounted, the cap 600 may be pushed to one side in the radial direction and threaded rotation of the cap 600 may occur. However, by providing two projections 630 at positions facing each other in the radial direction, such a situation can be easily avoided. Since the two projections 630 are provided at positions facing each other in the radial direction, it is possible to further reduce the possibility that the cap 600 is erroneously mounted to the incompatible ink outlet forming portion 400t that does not have the notch portion 477. In addition, when the number of the projections 640 is too large, the possibility that the projections 640 collide with other elements of the ink replenishment container 200 in the mounting process increases by the number of the projections 640, and thus there is a possibility that the mounting operation cannot be smoothly performed.

### B-2. Another Embodiment 2

In the above-described embodiment, in the plurality of female threads 654a, 654b, 654c, 654d, and 654e of the cap 600, as shown in FIG. 16, the shapes of the thread upper surface 654fa and the thread lower surface 654fb of the first female thread 654a are different from the shapes of the other female threads 654b, 654c, 654d, and 654e, but the present disclosure is not limited thereto. For example, the thread upper surface 654fa and the thread lower surface 654fb of the plurality of female threads 654a, 654b, 654c, 654d, and 654e may be the same.

### C. Other Aspects

The present disclosure is not limited to the above-described embodiments, and can be implemented in various aspects without departing from the gist of the disclosure. For example, the present disclosure can also be implemented in the following aspects. The technical features in the above-described embodiment that correspond to the technical features in each of the embodiments described below can be replaced or combined as appropriate in order to solve a part or all of the problems of the present disclosure or to achieve a part or all of the effects of the present disclosure. Further, when the technical features are not described as essential in the present specification, the technical features can be appropriately deleted.
(1) According to an aspect of the present disclosure, there is provided an ink replenishment container for replenishing ink to a printer including an ink introduction member having a flow path communicating with an ink tank and extending in a vertical direction, a receiving surface extending in a horizontal direction, a first hole that opens to the receiving surface and in which the ink introduction member is disposed, and a pair of second holes that open to the receiving surface and are disposed with the first hole interposed therebetween. The ink replenishment container includes a container main body portion configured to accommodate the ink, an ink outlet forming portion coupled to the container main body portion, and a cap configured to be attachable to and detachable from the ink outlet forming portion, in which the ink outlet forming portion includes an outlet portion configured to receive the ink introduction member and having a central axis, a protruding portion disposed in a region outside the outlet portion in a direction intersecting the central axis, extending in an axial direction along the central axis, and configured to have a portion of the protruding portion inserted into the second hole, a positioning portion disposed in a region outside the outlet portion in a direction intersecting the central axis of the outlet portion and configured to abut on the receiving surface in a state in which the ink introduction member is inserted into the outlet portion, and a male thread portion disposed below the protruding portion in an upright orientation in which the outlet portion faces upward, the protruding portion includes an upper protruding portion located above the positioning portion and a lower protruding portion located below the positioning portion in the upright orientation, the lower protruding portion includes a protruding main body portion and a notch portion recessed toward the central axis, the cap includes a top wall and a tubular side wall having the central axis, an inner surface of the side wall is provided with a female thread portion configured to be screwed with the male thread portion, and a projection disposed at a position above the female thread portion in a state in which the top wall is positioned above the side wall, and the projection is spaced from the protruding main body portion at a position facing the notch portion.

According to the above aspect, when the cap is to be mounted to the ink outlet forming portion that does not have the notch portion in the protruding portion, the projection interferes with the protruding portion, so that the user can easily notice that the cap is erroneously being mounted to an ink replenishment container having another type of ink outlet forming portion. Accordingly, the possibility that the cap is erroneously mounted to another type of ink outlet forming portion. In addition, since the possibility that the cap is erroneously mounted to another type of ink outlet forming portion is reduced, it is possible to suppress deterioration of the function of another type of ink outlet forming portion due to the cap. For example, it is possible to suppress damage or deformation of the protruding portion which does not have the notch portion due to the cap being forcibly mounted on another type of ink outlet forming portion. In addition, when the user attempts to mount the cap to the suitable ink outlet forming portion, the projection of the cap is spaced from the protruding main body portion without interfering with the protruding main body portion, and thus it is possible to easily mount the cap to the suitable ink outlet forming portion. Therefore, since the cap can be easily mounted to the suitable ink outlet forming portion, it is possible to suppress the ink from leaking to the outside of the ink replenishment container due to incomplete mounting of the cap. In addition, since the upper protruding portion is longer than the protruding main body portion of the lower protruding portion in the direction intersecting the central axis, that is in a radial direction around the central axis, it is possible to stabilize the upside-down posture of the ink replenishment container when the ink replenishment container is mounted on the printer for ink replenishment.
(2) In the above aspect, in the axial direction, a notch dimension which is a dimension of the notch portion and a projection dimension of the projection may have a relationship represented by the following Expression (1).

$$M 1 > P \times N + M 2 \qquad Expression ( 1 )$$

Here, M1 is the notch dimension, P is a pitch of the male thread portion, N is the number of engaged thread turns between the male thread portion and the female thread portion, and M2 is the projection dimension.

According to the above aspect, since the ink replenishment container has the relationship of the above-described Expression (1), when the male thread portion and the female thread portion are screwed to each other or when the screwing between the male thread portion and the female thread portion is released, the projection can pass through the notch portion or the projection can be located in the notch portion, and thus it is possible to suppress hindrance of the attachment/detachment operation of the cap with respect to the ink outlet forming portion.
(3) In the above aspect, the upper protruding portion may have an identification shape for identifying a type of the ink accommodated in the container main body portion.

According to the above aspect, the upper protruding portion can be used for identification to identify the type of ink.
(4) In the above aspect, the female thread portion of the cap may have a plurality of female threads, when the female thread located farthest from the top wall in the axial direction among the plurality of female threads is defined as a first female thread, and among respective threads of the plurality of female threads, a surface on a top wall side is defined as a thread upper surface, and a surface on a side opposite to the thread upper surface is defined as a thread lower surface, in the first female thread, an angle formed between a plane orthogonal to the central axis and the thread upper surface may be larger than an angle formed between the plane and the thread lower surface.

Here, when the cap is to be mounted to the ink outlet forming portion in an orientation different from the correct orientation, for example, in an inclined orientation, in the mounting operation process of the cap, there may be a case where the engagement between the first female thread of the female thread portion and the male thread portion is not correctly performed. In this case, a so-called deadlock state in which the rotation operation for the attachment/detachment operation of the cap is restricted occurs, and the attachment/detachment operation of the cap may not be performed. In this case, since the angle formed between the plane and the thread upper surface is larger than the angle formed between the plane and the thread lower surface in the first female thread, when the cap is pulled up in the first direction away from the ink outlet forming portion, the engagement between the thread upper surface of the first female thread and the male thread portion can be released, and thus the cap in the deadlock state can be removed from the ink outlet forming portion.
(5) In the above aspect, the projection of the cap may have an asymmetric shape as viewed in the axial direction, the projection of the cap may have a top surface portion forming a top portion of the projection, a first projection surface on a side where the cap is rotated in a closing direction, and a second projection surface on a side where the cap is rotated in an opening direction, and when viewed in the axial direction, an angle formed between a reference direction perpendicular to the top surface portion and the first projection surface may be smaller than an angle formed between the reference direction and the second projection surface.

According to the above aspect, when the cap is rotated in the closing direction with respect to the ink replenishment container, interference between the first projection surface and the protruding portion increases, and the projection is less likely to ride over the protruding portion. For this reason, it is easy for the user to notice that the cap is erroneously mounted to another type of incompatible ink outlet forming portion. On the other hand, the second projection surface having a large angle formed with the reference direction and a gentle inclination angle is likely to ride over the protruding portion. Therefore, even when the first projection surface rides over the protruding portion, the user can detach the cap from the incompatible ink outlet forming portion by rotating the cap in the opening direction.
(6) In the above aspect, the ink replenishment container may further include a spring valve disposed inside the ink outlet forming portion, the spring valve may include a seal portion in which a through-hole is formed in the axial direction, a valve body facing the seal portion in the axial direction, and a spring member that biases the valve body toward the seal portion so as to close the through-hole, thereby bringing the spring valve into a valve-closed state in which the valve body is in contact with the seal portion, the cap may have a center projection protruding from the top wall toward the valve body, and in a state in which mounting of the cap to the ink outlet forming portion is completed, the valve body may be pushed by the center projection in a direction opposite to a biasing direction of the spring member, thereby the valve body may be spaced from the seal portion and the spring valve may be brought into a valve-open state.

According to the above aspect, in a state in which the mounting of the cap to the ink outlet forming portion is completed, the spring valve enters the valve-open state, and thus it is possible to suppress an increase in the pressure in the container main body portion due to an environmental change such as changes in temperature or pressure.

The present disclosure can also be implemented in various other aspects. For example, the present disclosure can be implemented in the aspect such as a method for manufacturing an ink replenishment container.

What is claimed is:

1. An ink replenishment container for replenishing ink to a printer, the printer including
an ink introduction member having a flow path communicating with an ink tank and extending in a vertical direction,
a receiving surface extending in a horizontal direction,
a first hole that opens to the receiving surface and in which the ink introduction member is disposed, and
a pair of second holes that open to the receiving surface and are disposed with the first hole interposed therebetween,
the ink replenishment container comprising:
a container main body portion configured to accommodate the ink;
an ink outlet forming portion coupled to the container main body portion; and
a cap configured to be attachable to and detachable from the ink outlet forming portion, wherein
the ink outlet forming portion includes
an outlet portion configured to receive the ink introduction member and having a central axis,
a protruding portion disposed in a region outside the outlet portion in a direction intersecting the central axis, extending in an axial direction along the central axis, and configured to have a portion of the protruding portion inserted into the second hole,
a positioning portion disposed in a region outside the outlet portion in a direction intersecting the central axis of the outlet portion and configured to abut on the receiving surface in a state in which the ink introduction member is inserted into the outlet portion, and
a male thread portion disposed below the protruding portion in an upright orientation in which the outlet portion faces upward,
the protruding portion includes an upper protruding portion located above the positioning portion and a lower protruding portion located below the positioning portion in the upright orientation,
the lower protruding portion includes a protruding main body portion and a notch portion recessed toward the central axis,
the cap includes
a top wall and a tubular side wall having the central axis,
an inner surface of the side wall is provided with a female thread portion configured to be screwed with the male thread portion, and a projection disposed at a position above the female thread portion in a state in which the top wall is positioned above the side wall, and
the projection is spaced from the protruding main body portion at a position facing the notch portion.

2. The ink replenishment container according to claim 1, wherein
in the axial direction, a notch dimension which is a dimension of the notch portion and a projection dimension of the projection have a relationship represented by the following Expression (1),
$$M 1 > P \times N + M 2 \qquad Expression ( 1 )$$
where M1 is the notch dimension, P is a pitch of the male thread portion, N is the number of engaged thread turns between the male thread portion and the female thread portion, and M2 is the projection dimension.

3. The ink replenishment container according to claim 1, wherein
the upper protruding portion has an identification shape for identifying a type of the ink accommodated in the container main body portion.

4. The ink replenishment container according to claim 1, wherein
the female thread portion of the cap has a plurality of female threads, and
when the female thread located farthest from the top wall in the axial direction among the plurality of female threads is defined as a first female thread, and
among respective threads of the plurality of female threads, a surface on a top wall side is defined as a thread upper surface, and a surface on a side opposite to the thread upper surface is defined as a thread lower surface,
in the first female thread, an angle formed between a plane orthogonal to the central axis and the thread upper surface is larger than an angle formed between the plane and the thread lower surface.

5. The ink replenishment container according to claim 1, wherein
the projection of the cap has an asymmetric shape as viewed in the axial direction,
the projection of the cap has a top surface portion forming a top portion of the projection, a first projection surface on a side where the cap is rotated in a closing direction, and a second projection surface on a side where the cap is rotated in an opening direction, and
when viewed in the axial direction, an angle formed between a reference direction perpendicular to the top surface portion and the first projection surface is smaller than an angle formed between the reference direction and the second projection surface.

6. The ink replenishment container according to claim 1, further comprising:
a spring valve disposed inside the ink outlet forming portion, wherein
the spring valve includes
a seal portion in which a through-hole is formed in the axial direction,
a valve body facing the seal portion in the axial direction, and
a spring member that biases the valve body toward the seal portion so as to close the through-hole, thereby bringing the spring valve into a valve-closed state in which the valve body is in contact with the seal portion,
the cap has a center projection protruding from the top wall toward the valve body, and
in a state in which mounting of the cap to the ink outlet forming portion is completed, the valve body is pushed by the center projection in a direction opposite to a biasing direction of the spring member, thereby the valve body is spaced from the seal portion and the spring valve is brought into a valve-open state.
